(19) United States
(12) Patent Application Publication
(10) Pub. No.: US 2015/0215220 A1
(43) Pub. Date: Jul. 30, 2015

(54) METHOD AND APPARATUS TO ASSIST NETWORK TRAFFIC

(71) Applicants: Candy Yiu, Beaverton, OR (US); Ana Lucia A. Pinheiro, Portland, OR (US); Marta M. Tarradell, Hillsboro, OR (US)

(72) Inventors: Candy Yiu, Beaverton, OR (US); Ana Lucia A. Pinheiro, Portland, OR (US); Marta M. Tarradell, Hillsboro, OR (US)

(21) Appl. No.: 14/581,216

(22) Filed: Dec. 23, 2014

Related U.S. Application Data
(60) Provisional application No. 61/953,662, filed on Mar. 14, 2014.
(60) Provisional application No. 61/933,872, filed on Jan. 31, 2014.
(60) Provisional application No. 61/933,866, filed on Jan. 30, 2014.

(51) Int. Cl. H04L 12/859; H04W 72/04; H04W 28/02

(52) U.S. Cl. CPC H04L 47/2475; H04W 28/0215; H04W 28/0252; H04W 72/048

(57) ABSTRACT

Described is a User Equipment (UE) to communicate with an eNB on an LTE network, the UE comprising: EPS bearers, at least one of which is configured with a TFT, wherein the TFT includes one or more packet filters; a transmitter to transmit traffic over the LTE network to the eNB, the traffic having packets; and logic to configure the one or more packet filters for uplink transmission with an indicator, wherein the indicator to identify whether the packets in the traffic are attended. Described is a Public Data Network Gateway (PGW) comprising: logic to associate a packet filter of an uplink traffic flow with a packet filter in a downlink traffic flow; and logic to label packets for downlink traffic as attended or unattended in the downlink traffic flow when the associated packet filter of the uplink traffic flow is identified as attended or unattended, respectively.

### CLAIM OF PRIORITY

The present application claims priority under 35 U.S.C. §119(e) to U.S. Provisional Patent Application Ser. No. 61/953,662 filed Mar. 14, 2014, to U.S. Provisional Patent Application Ser. No. 61/933,872 filed Jan. 31, 2014, and to U.S. Provisional Patent Application Ser. No. 61/933,866 filed Jan. 30, 2014, and which are incorporated by reference in their entirety.

### BACKGROUND

Mobile and wireless networks experience significant variations in traffic load. For example, the number of connected devices present on the network can change in response to events, time of day, or the like. Similarly, emergency situations may cause a spike in communications or damage to network infrastructure reducing how much traffic a network can handle. In some situations, heavy loads may be managed using congestion controls (also referred to as access control functionalities or access controls) which may limit certain devices or types of traffic from using the network to increase the likelihood that important traffic will be communicated.

### BRIEF DESCRIPTION OF THE DRAWINGS

The embodiments of the disclosure will be understood more fully from the detailed description given below and from the accompanying drawings of various embodiments of the disclosure, which, however, should not be taken to limit the disclosure to the specific embodiments, but are for explanation and understanding only.

FIG. 1A illustrates bearer service architecture to process data traffic according to attended versus unattended classifications of a User Equipment (UE) and/or applications, according to some embodiments of the disclosure.

FIG. 1B illustrates a UE which is operable to process data traffic according to the attended versus unattended classification, according to some embodiments of the disclosure.

FIG. 1C illustrates an Evolved Universal Mobile Telecommunications System (UMTS) Terrestrial Radio Access Network (E-UTRAN) Node B (eNB) which is operable to process data traffic according to the attended versus unattended classification, according to some embodiments of the disclosure.

FIG. 2 illustrates a table of packet filter component type identifiers with an attention indicator identifier defined in a reserved section of the packet filter component type identifiers, according to some embodiments of the disclosure.

FIG. 3 illustrates a table of packet filter component type identifiers with an application attention indicator identifier defined in a reserved section of the packet filter component type identifiers, according to some embodiments of the disclosure.

FIG. 4 illustrates a packet filter to route packet traffic flow according to whether the packet is identified as being attended or unattended, according to some embodiments of the disclosure.

FIG. 5 illustrates a table of packet filter component type identifiers with application type and attention indicator identifiers defined in a reserved section of the packet filter component type identifiers, according to some embodiments of the disclosure.

FIG. 6 illustrates a table of packet filter component type identifiers with application type and application attention indicator identifiers defined in a reserved section of the packet filter component type identifiers, according to some embodiments of the disclosure.

FIG. 7 illustrates a flowchart for managing traffic according to packets being identified as attended or unattended, according to some embodiments of the disclosure.

FIG. 8 illustrates a flowchart for managing traffic according to packets being identified as attended or unattended, according to some embodiments of the disclosure.

FIG. 9 illustrates a UE with the apparatus capable of managing traffic according to packets being identified as attended or unattended, according to some embodiments of the disclosure.

### DETAILED DESCRIPTION

Currently, a number of access control functionalities are used in the 3rd Generation Partnership Project (3GPP) to selectively disable or bar devices or types of traffic from being used over a network. 3GPP is a collaboration between groups of telecommunications associations, known as the Organizational Partners. Currently, there are multiple ways for the network to perform congestion control.

For example, Access Class Barring (ACB) allows the network to forbid User Equipment (UEs) from having initial Random Access Channel (RACH) access in specific cells. Service Specific Access Control (SSAC) is another example that allows the network to forbid UEs from initiating access for internet protocol (IP) multimedia services (IMS) voice or video. New work items in the 3GPP are studying new methods to perform congestion control based on application information. These new work items in 3GPP consist of: Smart Congestion Mitigation (SCM), Application Specific Congestion Control for Data Communication (ACDC), and User Plane Congestion Management (UPCON).

SCM and ACDC, combined with the existing mechanisms, provide the network with mechanisms to control User Equipment (UEs) that are trying to access the network, depending on the type of service or application the user wants to initiate. Here, UE is any device used directly by an end-user to communicate. It can be a handheld telephone, a laptop computer equipped with a mobile broadband adapter, or any other device. A UE connects to the base station Node B/eNodeB as specified in the European Telecommunications Standards Institute (ETSI) 125/136-series and 3GPP 25/36-series of specifications. A UE roughly corresponds to the mobile station (MS) in Global System for Mobile Communications (GSM) systems.

SCM addresses UEs in idle mode only, and ACDC addresses UEs in both idle and connected modes (in connected mode, the UE is already connected running one service, say voice, and the UE wants to start a new service, say video). UPCON on the other hand, addresses UEs in connected modes that encounter congestion in the user plane. The objective of UPCON is to manage user plane traffic when Radio Access Network (RAN) congestion occurs. Therefore, one problem is to select the appropriate user plane traffic flows to be subjected to congestion management. Approaches for selecting user plane traffic flows to be subjected to congestion management may affect one or more subscribers, one or more applications, or one or more types of traffic.

One approach to managing user plane congestion is to control all the traffic for a given subscriber without further considering the nature of that subscriber's traffic flows. A second candidate attribute in identifying the traffic to be managed is the type of application. Some types of application require near real-time handling of traffic while others may be relatively less time sensitive. Under user plane congestion conditions, the less time sensitive application traffic should be controlled before the more time sensitive application traffic.

Another approach to managing congestion is to control certain types of traffic. An application may involve multiple types of traffic (e.g., a social networking application may involve user browsing among friends' postings, then streaming a video posted by a friend). Hence, this approach may affect some types of traffic for a given application but not others. It may therefore be seen more finer-grained than user plane traffic management controls on an application basis. Another aspect for traffic management is whether or not the user is attending the specific application. Creating controls that allow the combination of types of traffic, together with the information about application attendance, may be an effective approach to improve the user's quality of experience and the user's perception of the network performance.

The solutions in UPCON discussed so far in 3GPP are based on the type of application and types of ongoing traffic in the cell to perform congestion control. Part of the UPCON objectives is to handle the congestion based on attended versus unattended traffic to limit the unattended traffic.

Some embodiments describe a method and apparatus for handling congestion in the network based on attended versus unattended traffic. In some embodiments, the UE is responsible for blocking the unattended traffic when the network requests it and/or is based on a configuration. In some embodiments, the UE is configured according to applications that are subject to being blocked.

For example, applications can be subject to being blocked when the network sends an indication, when applications are listed as exempt, and/or by default actions for applications that are not explicitly identified. In some embodiments, if the application is subject to being blocked and is identified as unattended, the UE internally blocks the uplink (UL) traffic generated by the application. In some embodiments, if the application is exempt from being blocked or is identified as attended, the UE does not block the UL traffic generated by the application.

In some embodiments, mechanisms are described for congestion control according to whether an application is classified as attended versus unattended. In some embodiments, a generic indicator is defined that identifies if the UE is attended or not. For example, a UE attention indicator is defined and used to assist the network to filter unattended traffic or attended traffic. In some embodiments, the value for the UE attention indicator may be determined when a display screen of the UE is turned off, or using feedback from a user or a sensor in the UE. In some embodiments, an indicator and associated hardware (e.g., registers) is defined within the UE that allows the UE to track which applications are attended versus unattended via the indicator.

In some embodiments, the attention indicator can be anything generated by the UE. For example, the attention indicator can be generated by the operating system (OS), application, hardware, etc. In some embodiments, in addition to existing methods and indicators to assist the network to classify traffic, a user attention indicator is used by the network to further classify traffic effectively. This methodology can be used for congestion control, traffic prioritization, rate shaping functions, etc.

In some embodiments, the methodology for congestion control applies to the UL because the UE knows whether the traffic generated by the UE is attended or unattended. In some embodiments, the methodology for congestion control applies to the downlink (DL) cases of UE-pull-based applications. UE-pull-based applications are applications where the UE sends a request and DL transmission happens as a result of the request.

For instance, there are many applications run on the UE that pull data from the network periodically without user interaction (e.g. e-mail, Twitter®, Facebook®, etc.). In that case, the UL traffic of the request may not be large, but potentially the DL traffic caused by the periodic update may be substantial. In some embodiments, by blocking the UL requests using the attended/unattended indicator, the UE essentially blocks the DL responses also.

In the following description, numerous details are discussed to provide a more thorough explanation of embodiments of the present disclosure. It will be apparent, however, to one skilled in the art, that embodiments of the present disclosure may be practiced without these specific details. In other instances, well-known structures and devices are shown in block diagram form, rather than in detail, in order to avoid obscuring embodiments of the present disclosure.

Note that in the corresponding drawings of the embodiments, signals are represented with lines. Some lines may be thicker, to indicate more constituent signal paths, and/or have arrows at one or more ends, to indicate primary information flow direction. Such indications are not intended to be limiting. Rather, the lines are used in connection with one or more exemplary embodiments to facilitate easier understanding of a circuit or a logical unit. Any represented signal, as dictated by design needs or preferences, may actually comprise one or more signals that may travel in either direction and may be implemented with any suitable type of signal scheme.

Throughout the specification, and in the claims, the term “connected” means a direct electrical or wireless connection between the things that are connected, without any intermediary devices. The term “coupled” means either a direct electrical or wireless connection between the things that are connected or an indirect connection through one or more passive or active intermediary devices. The meaning of “a,” “an,” and “the” include plural references. The meaning of “in” includes “in” and “on.”

The terms “substantially,” “close,” “approximately,” “near,” and “about,” generally refer to being within +/−20% of a target value. Unless otherwise specified the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking or in any other manner.

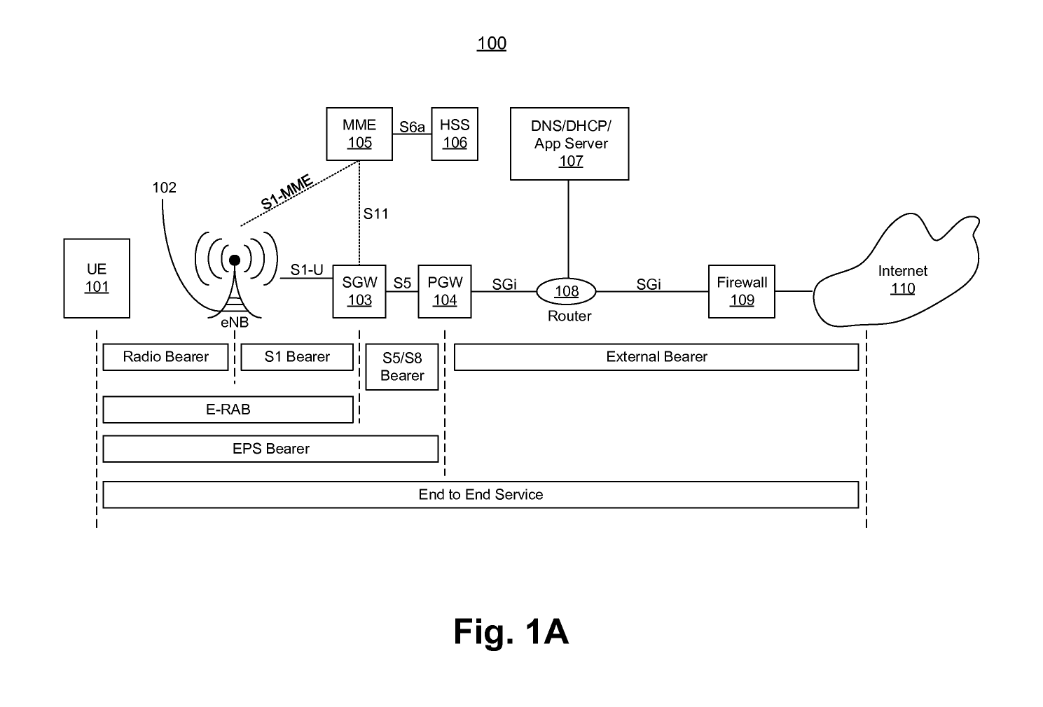

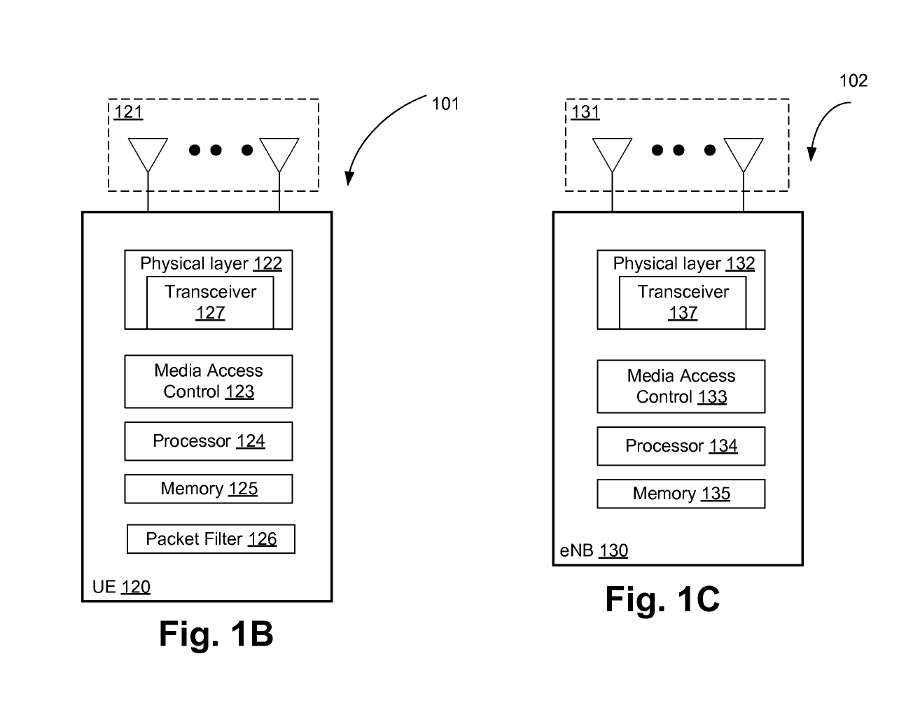

FIG. 1A illustrates bearer service architecture 100 to process data traffic according to attended versus unattended classifications of a UE and/or applications, according to some embodiments of the disclosure. Architecture 100 comprises UE 101, Evolved Universal Mobile Telecommunications System (UMTS) Terrestrial Radio Access Network (E-UTRAN) Node B (eNB) 102, Serving Gateway (SGW) 103, Public Data Network (PDN) Gateway (GW) i.e., (PGW) 104, Mobility Management Entity (MME) 105, Home Subscriber Server (HSS) 106, Dynamic Host Configuration Protocol (DHCP) Application (App.) Server or Domain Name System (DNS) App. Server 107, Router 108, Firewall 109, and the Internet 110.

In some embodiments, UE 101 is any device used directly by an end-user to communicate. It can be a handheld telephone, a laptop computer equipped with a mobile broadband adapter, or any other device. UE 101 connects to the base station Node B/eNodeB 102 as specified in the ETSI 125/136-series and 3GPP 25/36-series of specifications. UE 102 roughly corresponds to the mobile station (MS) in Global System for Mobile Communications (GSM) systems. In some embodiments, UE 101 may have a register to store a UE attention indicator to assist the network to filter unattended traffic or attended traffic. Various bearers (i.e., carriers) are used to provide End-to-End Service from the UE to the Internet, for example. An embodiment of UE 101 is described with reference to FIG. 1B.

Referring back to FIG. 1A, E-UTRAN Node B 102, also known as the Evolved Node B, (abbreviated as eNodeB or eNB) is the element in E-UTRA of the Long Term Evolution (LTE) standard that is the evolution of the element Node B in UMTS Terrestrial Radio Access (UTRA) of UMTS. UMTS is a third generation mobile cellular system for networks based on the Global System for Mobile Communications (GSM) standard. It is the hardware that is connected to the mobile phone network that communicates directly with the UEs, like a base transceiver station (BTS) in GSM networks. Traditionally, a Node B has minimum functionality, and is controlled by a Radio Network Controller (RNC). However, with eNB 102, there is no separate controller element. This simplifies the architecture and allows lower response times.

eNB 102 interfaces with the System Architecture Evolution (SAE) core (also known as the Evolved Packet Core (EPC)) and other eNBs (not shown). For example, the eNB 102 uses the S1-AP protocol on the S1-MME interface with the MME for control plane traffic. eNB 102 also uses the General Packet Radio Service (GPRS) Tunneling Protocol GTP-U), which is the defining IP-based protocol of the GPRS core network protocol on the S1-U interface with the SGW for user plane traffic. Collectively the S1-MME and S1-U interfaces are known as the S1 interface, which represents the interface from eNB 102 to the Evolved Packet Core (EPC). An embodiment of eNB 102a/b/c/d is described with reference to FIG. 1C.

Referring back to FIG. 1A, interface between the SGW 103 and the MME 105 is S11. SGW 103 terminates the interface toward RAN, and routes data packets between RAN and EPC. In addition, SGW 103 may be a local mobility anchor point for inter-eNB handovers and also may provide an anchor for inter-3GPP mobility. Other responsibilities may include lawful intercept, charging, and some policy enforcement. MME 105 is similar in function to the control plane of legacy Serving GPRS Support Nodes (SGSN). MME 105 manages mobility aspects in access such as gateway selection and tracking area list management. Interface between the MME 105 and the HSS 106 is S6a. Interface between PGW 104 and Router 108 is SGi. Interface between Router 108 and Firewall 109 is SGi.

PGW 104 terminates the SGi interface toward the packet data network (PDN). PGW 104 routes data packets between EPC and the external PDN (not shown), and may be a key node for policy enforcement and charging data collection. It may also provide an anchor point for mobility with non-LTE accesses. The external PDN can be any kind of IP network, as well as an IP Multimedia Subsystem (IMS) domain. PGW 104 and SGW 103 may be implemented in one physical node or separate physical nodes.

An UL (uplink) Traffic Flow Template (TFT) in UE 101 binds a traffic flow or a Service Data Flow (SDF) to an Evolved Packet System (EPS) Bearer (i.e., carrier) in the UL direction. Multiple traffic flows can be multiplexed onto the same EPS Bearer by including multiple uplink packet filters in the UL TFT.

A DL (downlink) TFT in PGW 104 binds a traffic flow to an EPS Bearer in the DL direction. Multiple traffic flows can be multiplexed onto the same EPS Bearer by including multiple downlink packet filters in the DL TFT.

An Enhanced Radio Access Bearer (E-RAB) transports the packets of an EPS Bearer between UE 101 and SGW 103 in the EPC (not explicitly marked). When an E-RAB exists, there is a one-to-one mapping between this E-RAB and an EPS Bearer.

A data Radio Bearer transports the packets of an EPS Bearer between UE 101 and eNB 102. When a data Radio Bearer exists, there is a one-to-one mapping between this data Radio Bearer and the EPS bearer/E-RAB. An S1 Bearer transports the packets of an E-RAB between eNB 102 and SGW 103. An S5/S8 Bearer transports the packets of an EPS Bearer between SGW 103 and PGW 104.

UE 101 stores a mapping between an UL packet filter and a data Radio Bearer to create the binding between a traffic flow and a data Radio Bearer in the UL. PGW 104 stores a mapping between a DL packet filter and an S5/S8a Bearer to create the binding between a traffic flow and an S5/S8a Bearer in the DL. eNB 102 stores a one-to-one mapping between a data Radio Bearer and an S1 Bearer to create the binding between a data Radio Bearer and an S1 Bearer in both the UL and DL. SGW 103 stores a one-to-one mapping between an S1 Bearer and an S5/S8a Bearer to create the binding between an S1 Bearer and an S5/S8a Bearer in both the UL and DL.

A PDN connection is comprised of several EPS bearers, each EPS Bearer (except for the default EPS Bearer) has a Traffic Flow Template (TFT) associated with it. The default EPS Bearer may have a TFT, but it may not require one. When the UE needs to send an UL user data packet, it checks the packet filters across all TFTs to check whether there is a match with one of them. Each packet filter comes with a packet filter evaluation precedence. In some embodiments, UE 101 checks the packet filters starting with the one having the highest evaluation precedence. As soon as UE 101 finds a match, it delivers the user data packet to the respective associated EPS Bearer for UL transmission. The same process happens in PGW 104 for the DL. The packets that do not match any packet filters are then left for the default bearer.

In some embodiments, flow of traffic is further controlled according to UE 101 attention indicator or application attention indicator that indicates whether the packet in the traffic is attended or unattended. Here, attended traffic generally refers to traffic data generated when a user (e.g., of UE 101) is interacting and actively using any application (e.g., on UE 101). The term unattended traffic generally refers to the traffic data generated (e.g., by UE 101) when the user is not actively using the application at the same time as the traffic is generated.

In some embodiments, PGW 104 comprises logic to bind a packet filter of an uplink traffic flow with a packet filter in a downlink traffic flow. In some embodiments, PGW 104 comprises logic to label packets for downlink traffic as attended or unattended in the downlink traffic flow when the associated packet filter of the uplink traffic flow is identified as attended or unattended, respectively. In some embodiments, eNB 102 applies the label to perform downlink packet scheduling. In some embodiments, eNB 103 notifies UE 101 of congestion, where UE 101 prioritizes the traffic flow in response to the notification.

Classifying traffic as background or non-background traffic may not capture whether traffic is attended or unattended. The term background traffic is generally used to classify the type of application that runs in the background all the time. However, there are applications that sometimes are running in the background and other times are not, in which case they cannot be classified as background. For example, Skype® application may be running in the background to receive updates, while if the user is talking through the Skype® application, the traffic generated is not background traffic.

Various embodiments describe several ways to manage traffic by using the information related to the fact that an application might be attended versus unattended.

In some embodiments, a first generic indicator is defined that identifies if UE 101 is attended or not. This indicator is referred to here as the attention indicator. The attention indicator in some embodiments may indicate whether the traffic is attended traffic or is unattended traffic. For example, traffic data which is generated when the display screen of UE 101 is turned off may be classified as unattended traffic while traffic data which is generated via feedback from a user of UE 101 or some sensor in UE 101 may be classified as attended traffic.

In some embodiments, the classification of various types of traffic data can be defined as attended or unattended by a communication standard, user preference, system operator, etc. For example, it can be a hardware sensor that continuously senses how the user uses the device; it can also be an OS in the device that determines whether the user is interacting with the application; it can also be a piece of software running an algorithm which classifies traffic as attended versus unattended; it could be pre-configured in the device, or the user could pre-configure in the device, whether a given traffic should be considered attended or unattended in different situations, etc.

In some embodiments, a second indicator is defined which may be a creation of a new functionality within UE 101 to track which applications are attended versus unattended via the second indicator. The second indicator here is referred to as the Application attention indicator. In some embodiments, the user attention indicator can be combined with any existing method to assist the network to further classify traffic more effectively. For example, user attention indicator can be combined with an Application type indicator, where the Application type indicator indicates the type of application being used.

In some embodiments, attention indicator is per UE 101 and not per application. Consider an example in which one application is running in each of two UEs that keeps them active. Say, one UE is running a Global Positioning System (GPS) application to a friend's house when the user is driving real-time, and another UE is downloading a movie so that the user can watch it later offline. Both applications are web traffic, however, the user is viewing the GPS map on the UE screen for the driving case while the user may not be checking the video download by the other UE and that application may be running in the background. In this example, traffic congestion over the network can be managed by assigning a higher priority to the GPS application over the application which is downloading a movie since the use of that application is not on the UE screen once the user clicks the download link or button.

In some embodiments, UE 101 sends an attention indicator to the network (i.e., eNB 102, SGW 102 and other components of UL path) to indicate whether the user is actually interacting with the device (e.g., actively using the phone) or not. In such embodiments, the network can take into account that UE 101 is waiting for a response when the indicator is set to true. In some embodiments, traffic data can be prioritized over other traffic data according to the polarity of the attention indicator. In some embodiments, when the attention indicator is not set, the traffic data can be delayed under congestion.

While the embodiments are described with reference to setting the attention indicator to logic 1 (i.e., true) to indicate that the traffic data is attended traffic data, and to setting the attention indicator to logic 0 (i.e., false) to indicate that the traffic data is unattended traffic data, the process can be reversed. For example, in some embodiments, no indication (i.e., when attention indicator is set to logic 0) may mean that the UE is an attending UE and the traffic associated with the attending UE is high priority traffic. No indication may also imply that the UE is an un-attending UE and the traffic associated with the un-attending UE is lower priority traffic.

In some embodiments, the attention indicator is transmitted by UE 101 to the network. In some embodiments, the OS or the hardware or a middleware or other application(s) generates the attention indicator. In some embodiments, the network requests the attention indicator. In some embodiments, the attention indicator is transmitted periodically to the network. For example, based on settings of UE 101 or configurable settings coming from the network, the attention indicator is provided to the network.

In some embodiments, the attention indicator is associated with each application being run on UE 101. For example, each application executing on UE 101 can indicate if the user of UE 101 is currently using UE 101 (i.e., whether the traffic data transmitted by UE 101 is attended or unattended traffic data). This indication can help the network identify which application's packet needs to have a higher priority.

In some embodiments, UE 101 includes apparatus (and/or associated methods performed by the apparatus) to send this attention indicator to the network. Such methods, for example, could be part of Radio Resource Control (RRC) messages when UE 101 is initially starting a connection with the peer application. Optionally, UE 101 may include some label inside the packets at the protocol stack level, e.g., in a Media Access Control (MAC) header to indicate if the packets coming in that channel are attended or unattended. Some embodiments describe a method or scheme for the network to find out if a specific service or traffic data is attended or unattended. In some embodiments, the OS or hardware or other application generates the application attention indicator. In some embodiments, the application attention indicator can be used to prioritize applications running on UE 101 to manage network traffic congestion.

For example, if both applications, discussed with reference to the example of two applications running on two different UEs respectively, are used by the same UE, the user will be on the GPS screen. In such an example, the application attention indicator is most likely to indicate that the GPS traffic data has higher priority over the movie downloading application.

Currently, each TFT is associated with an EPS Bearer. In some embodiments, attention indicator(s) (e.g., UE attention indicator or application attention indicator) are added alternatively in the packet filter to also be able to identify if the traffic flow is attended or unattended. In some embodiments, a method is described to perform traffic congestion control for UL and DL using the new packet filter components. In addition, the new packet filter parameters/components can be utilized by UE 101 and the network to assist in several other functions such as traffic prioritization, data rate shaping, etc.

FIG. 1B illustrates UE 120 (e.g., UE 101) which is operable to process data traffic according to the attended versus unattended classification, according to some embodiments of the disclosure. It is pointed out that those elements of FIG. 1B having the same reference numbers (or names) as the elements of any other figure can operate or function in any manner similar to that described, but are not limited to such.

In some embodiments, UE 120 may include physical (PHY) layer circuitry 122, Media Access Control (MAC) circuitry 123, Processor 124, Memory 125, and Packet Filter(s) 126. So as not to obscure the embodiments, a high level simplified architecture of UE 120 is described. A person skilled in the art would appreciate that other components (not shown) are used in addition to the ones shown to form a complete UE. In some embodiments, PHY layer circuitry 122 includes Transceiver 127 for transmitting and receiving signals to and from eNB 102, other eNBs, other UEs or other devices using one or more antennas 201. In some embodiments, MAC circuitry 123 is used for controlling access to the wireless medium. In some embodiments, Processor 124 and Memory 125 are arranged to perform the operations described with reference to some embodiments.

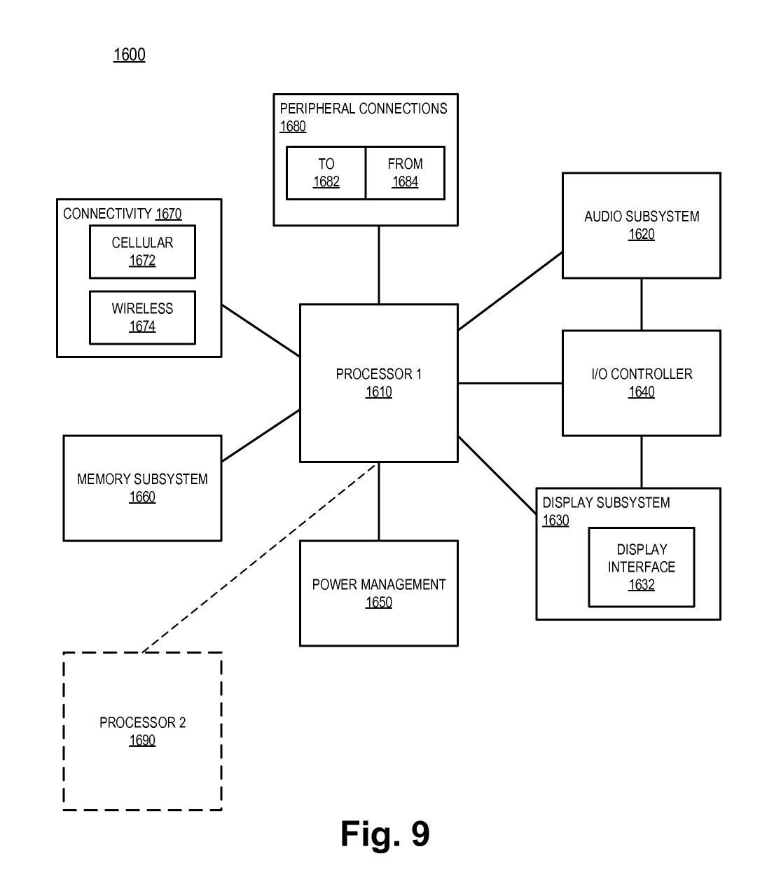

In some embodiments, antennas 121 may comprise one or more directional or omnidirectional antennas, including monopole antennas, dipole antennas, loop antennas, patch antennas microstrip antennas, coplanar wave antennas, or other types of antennas suitable for transmission of Radio Frequency (RF) signals. In some multiple-input multiple-output (MIMO) embodiments, antennas 121 are separated to take advantage of spatial diversity. FIG. 9 describes another embodiment of UE 101.

FIG. 1C illustrates eNB 130 (e.g., eNB 102) which is operable to process data traffic according to the attended versus unattended classification, according to some embodiments of the disclosure. It is pointed out that those elements of FIG. 1C having the same reference numbers (or names) as the elements of any other figure can operate or function in any manner similar to that described, but are not limited to such.

In some embodiments, eNB 130 may include PHY layer circuitry 132, MAC circuitry 133, Processor 134, and Memory 135. So as not to obscure the embodiments, a high level simplified architecture of eNB is described. A person skilled in the art would appreciate that other components (not shown) are used in addition to the ones shown to form a complete eNB. In some embodiments, PHY layer circuitry 132 includes Transceiver 137 for transmitting and receiving signals to and from eNB 102, other eNBs, other UEs or other devices using one or more antennas 301. In some embodiments, MAC circuitry 133 is used for controlling access to the wireless medium. In some embodiments, Processor 134 and Memory 135 are arranged to perform the operations described with reference to some embodiments.

In some embodiments, antennas 131 may comprise one or more directional or omni-directional antennas, including monopole antennas, dipole antennas, loop antennas, patch antennas microstrip antennas, coplanar wave antennas, or other types of antennas suitable for transmission of RF signals. In some MIMO embodiments, antennas 131 are separated to take advantage of spatial diversity.

Although UE 120 and eNB 130 are each described as having several separate functional elements, one or more of the functional elements may be combined and may be implemented by combinations of software-configured elements and/or other hardware elements. In some embodiments of this disclosure, the functional elements can refer to one or more processes operating on one or more processing elements. Examples of software and/or hardware configured elements include Digital Signal Processors (DSPs), one or more microprocessors, DSPs, Field-Programmable Gate Arrays (FPGAs), Application Specific Integrated Circuits (ASICs), Radio-Frequency Integrated Circuits (RFICs), etc.

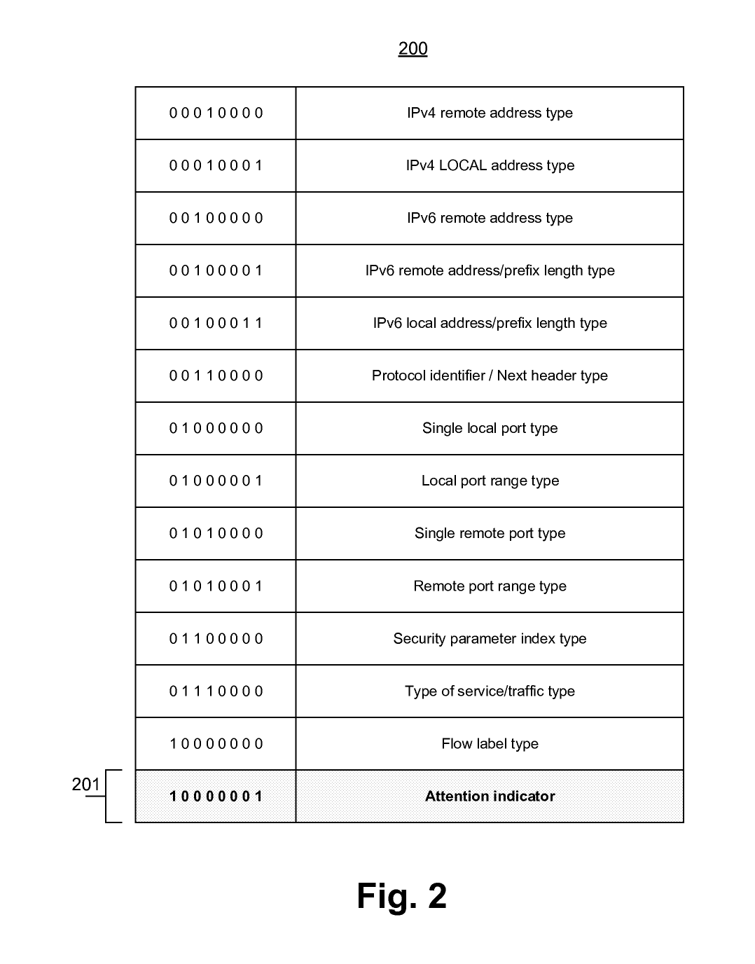

FIG. 2 illustrates Table 200 showing packet filter component type identifiers with an attention indicator identifier defined in a reserved section of the packet filter component type identifiers, according to some embodiments of the disclosure. It is pointed out that those elements of FIG. 2 having the same reference numbers (or names) as the elements of any other figure can operate or function in any manner similar to that described, but are not limited to such.

Table 200 shows traditional packet filter components plus an identifier for an attention indicator, according to some embodiments. The components of the packet filter comprise IPv4 remote address type (00010000), IPv4 local address type (00010001), IPv6 remote address type (00100000), IPv6 remote address/prefix length type (00100001), IPv6 local address/prefix length type, Protocol identifier/Next header type (00110000), Single local port type (01000000), Local port range type (01000001), Single remote port type (01010000), Remote port range type (01010001), Security parameter index type (01100000), Type of service/traffic class type (01110000), and Flow label type (10000000). In some embodiments, the attention indicator is defined using the reserved section 201 of the traditional packet filter. While the embodiments define the attention indicator identifier with “10000001,” other values for the identifier may be used to define the attention indicator so long as it is a unique identifier among the packet filter identifiers.

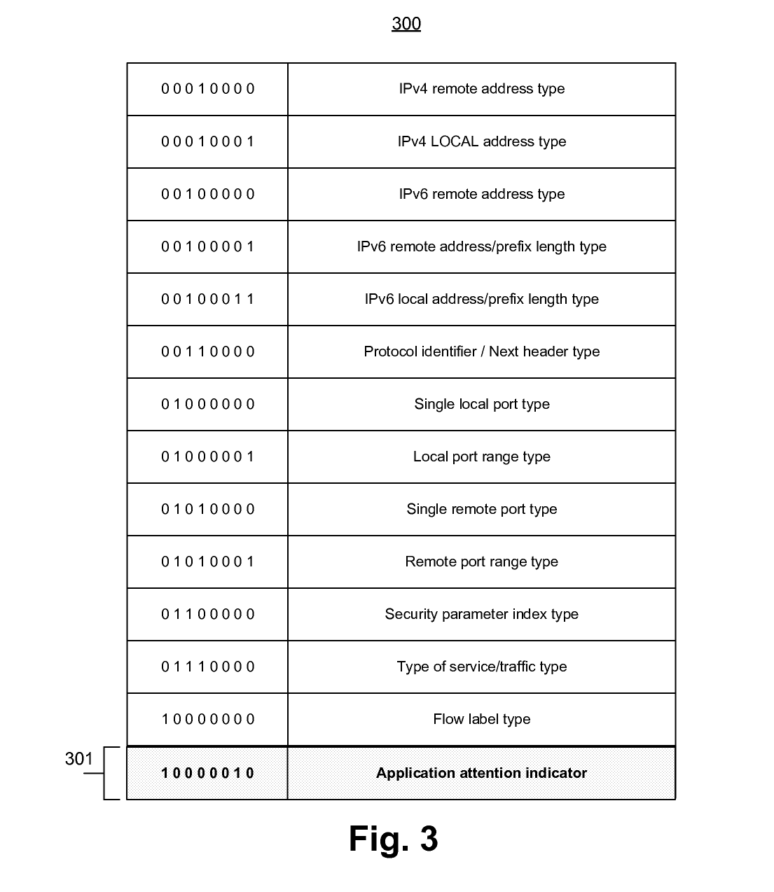

FIG. 3 illustrates Table 300 showing packet filter component type identifiers with an application attention indicator identifier defined in a reserved section of the packet filter component type identifiers, according to some embodiments of the disclosure. It is pointed out that those elements of FIG. 3 having the same reference numbers (or names) as the elements of any other figure can operate or function in any manner similar to that described, but are not limited to such.

Table 300 shows traditional packet filter components (like Table 200) plus an identifier for an application attention indicator, according to some embodiments. While the embodiments define the application attention indicator identifier with “10000010,” other values for the identifier may be used to define the application attention indicator so long as it's a unique identifier among the packet filter identifiers.

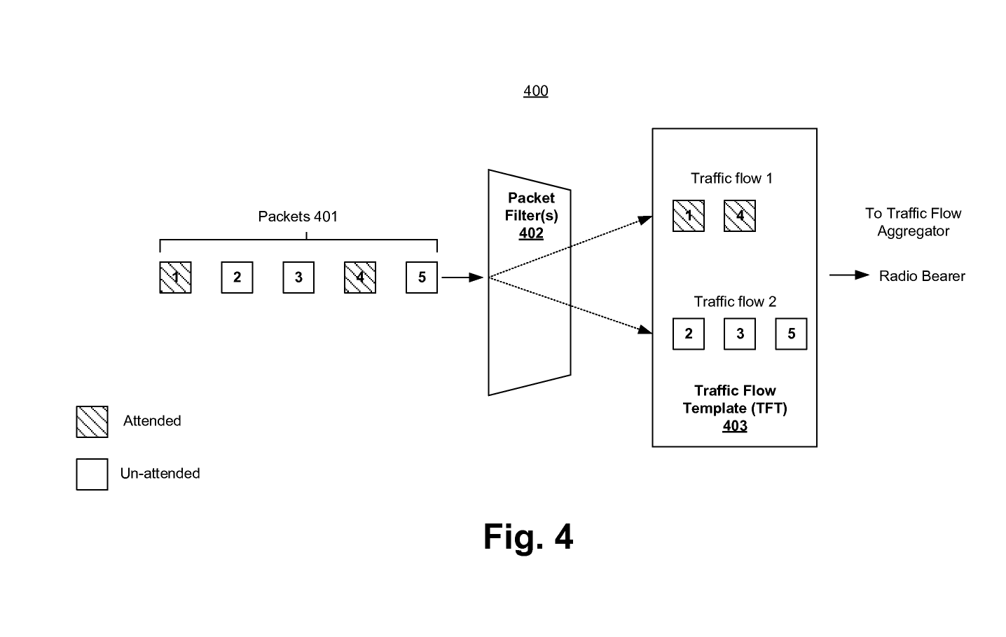

FIG. 4 illustrates the frontend of system 400 in which a packet filter routes packet traffic flow according to whether the packet is identified as being attended or unattended, according to some embodiments of the disclosure. It is pointed out that those elements of FIG. 4 having the same reference numbers (or names) as the elements of any other figure can operate or function in any manner similar to that described, but are not limited to such.

In some embodiments, frontend of system 400 of UE 101 comprises packets 401, packet filter(s) 402, and TFT 403. The function of packet filter 402 (defined, for example, as Table 200 and Table 300) is to inspect packets 401 and match the information in the packet (shown as one of the boxes of packets 401) with the filter contents. Based on this match, packet filter 402 assigns the packet to a specific traffic flow.

Each EPS bearer as shown with reference to FIG. 1A is associated with a Quality of Service (QoS). A TFT 403 is always assigned to a dedicated bearer and it is not required in a default bearer. In some embodiments, TFT 403 includes one or more packet filters. Therefore a packet filter maps into an EPS bearer. The relationship can be expressed as

Single EPS bearer [symbol] Quality of Service [symbol] Single TFT [symbol] Multiple packet filters

System 400 is a simplified example in which part of UE 101 sends packets 401 to one or more packet filters 402 which routes the packets to different traffic flows according to the packet filter content. In this example, five packets are shown and numbered as 1 through 5. Here, packets 401 with a pattern are packets indicating attention indicator being high (i.e., the packet is part of an attended traffic data) while packets 401 without a pattern are packets indicating the attention indicator being low (i.e., the packet is part of an unattended traffic data). The same example also applies to application attention indicator such that the packets with a pattern are packets indicating the application attention indicator being high (i.e., the packet is part of an attended traffic data), and packets without a pattern are packets indicating the application attention indicator being low (i.e., the packet is part of an unattended traffic data).

In some embodiments, if the packet has a pattern, the packet goes into Traffic flow 1 of TFT 403. In some embodiments, if the packet is without a pattern it goes to the Traffic flow 2 of TFT 403. In some embodiments, the packet filter 402 inspects the packet and compares with the filter content (in this case it is a pattern which represents whether the packet is attended or unattended), and routes the packet accordingly. In LTE, packet filter components such as IP addresses and port numbers allow UE 101 and PGW 104 to filter every packet. In some embodiments, packet filters 402 allow that multiple services be mapped into the same EPS bearer. In some embodiments, packet filter 402 is applied in UE 101 in the UL and in PGW 104 in the DL.

In some embodiments, packet filters 402 are configured in UE 101 and the network (currently defined in PGW 104 but it might be done in other network nodes such as eNB 102). In some embodiments, each packet filter has associated a new indicator about the attended characteristics of the packets coming from the filter; this indicator could be configured with two options, one with an attention indicator equal to “attended” and one with attention indicator equal to “unattended.” This means that the same traffic flow can be mapped into a different packet filter depending on whether or not the user is currently attending the application (e.g., viewing the application) or the same packet filter may act as an attended or unattended filter depending on the nature of the packets mapped to it. Based on this information, packets may be routed to different traffic flows within the same EPS bearer.

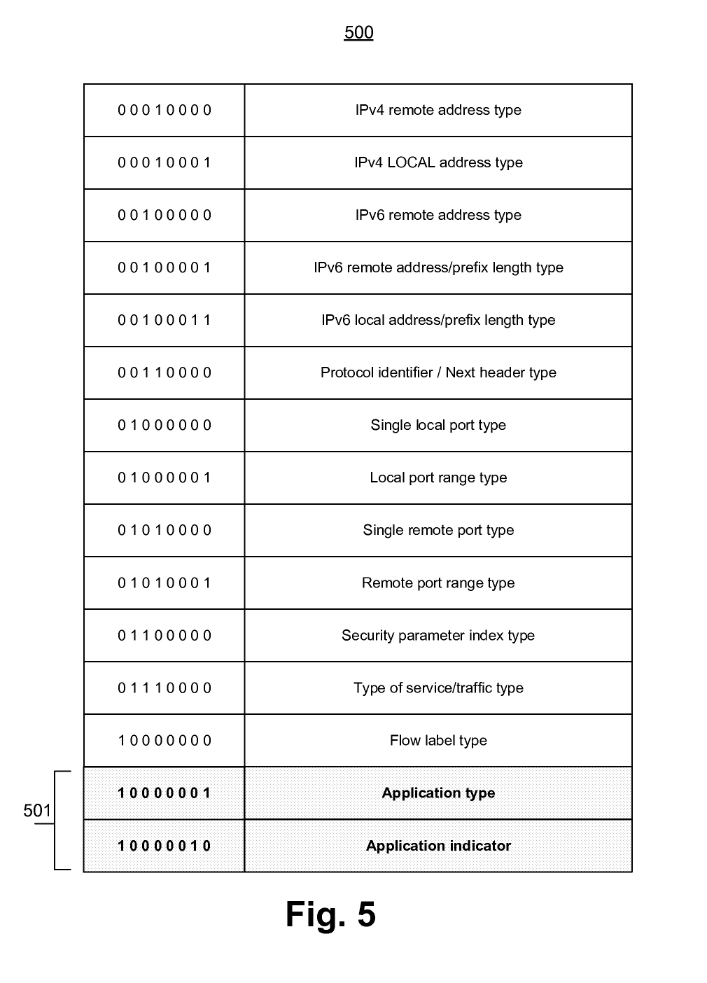

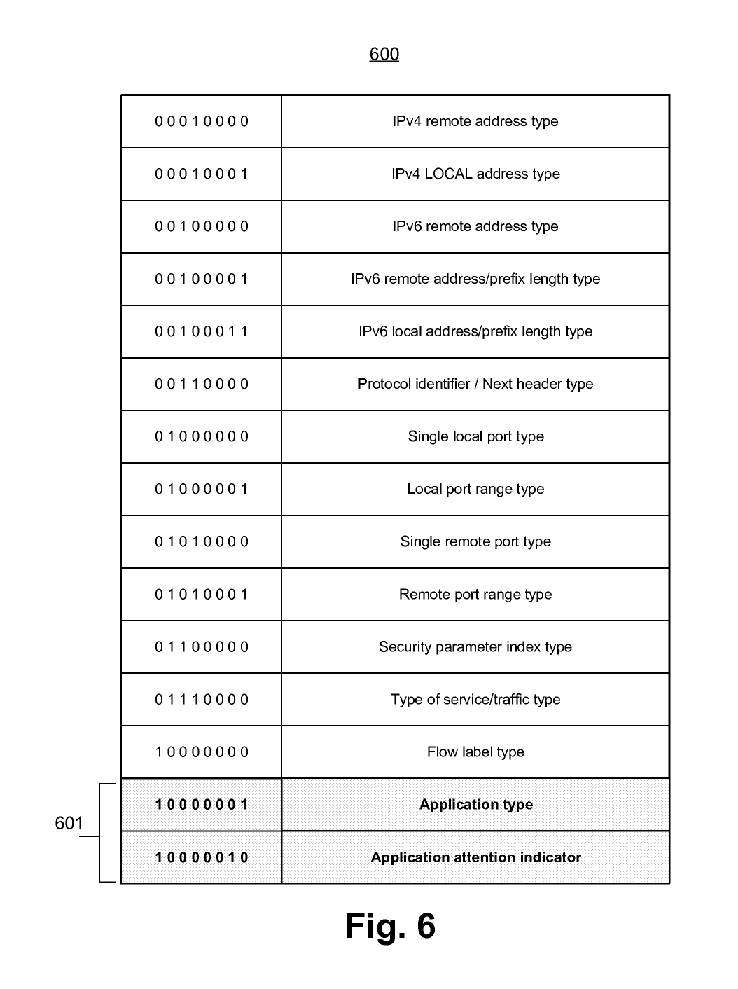

FIG. 5 illustrates Table 500 showing packet filter component type identifiers with application type and attention indicator identifiers defined in a reserved section of the packet filter component type identifiers, according to some embodiments of the disclosure. It is pointed out that those elements of FIG. 5 having the same reference numbers (or names) as the elements of any other figure can operate or function in any manner similar to that described, but are not limited to such.

In some embodiments, for handling congestion in the UL, congestion control can be performed per packet filter. In some embodiments, for the congestion control mechanism to work together with this mechanism (i.e., using attended/unattended indicator(s)), two new parameters in the reserved region 501 can be defined for the packet filters, one to give the attention indicator and another to give the congestion level/priority (i.e., Application type).

In some embodiments, to handle congestion in the UL and DL, different packet filters can be mapped into different EPS bearers. For example, if two bearers are established, then the attended traffic can be mapped into one bearer and the unattended traffic can be mapped to another bearer. In some embodiments, to perform congestion control in the UL, eNB 102 can control the traffic based on the EPS bearer, or just based on the packet filters. In some embodiments, for the DL, eNB 102 knows which packets are mapped to which bearer, and it maps the packets from that flow into the same bearer in the DL. In some embodiments, as the bearers are assigned attended versus unattended traffic, the eNB directly knows which packets are going to attended services versus unattended services.

Some applications need immediate delivery (i.e., no delay in delivery). For example, applications transmitting voice or voice over IP need immediate delivery. But some applications require immediate attention only when the user is currently paying attention to it. For instance, in spam advertisement: if the user did not sign up for an advertisement, it may be considered unattended and the advertisement can be the lowest priority traffic. In some embodiments, traffic congestion can be managed by combining application type and attention indicator in the packet filter.

Table 500 shows traditional packet filter components (like Tables 200 and 300) plus identifiers for application type (10000001) and attention indicator (10000010) in the reserved region 501, according to some embodiments. While some embodiments define the application type identifier with “10000001” and attention indicator with “10000010” other values for the identifiers may be used to define the application type and attention indicators so long as the identifiers are unique identifiers in the packet.

FIG. 6 illustrates Table 600 showing packet filter component type identifiers with application type and application attention indicator identifiers defined in a reserved section of the packet filter component type identifiers, according to some embodiments of the disclosure. It is pointed out that those elements of FIG. 6 having the same reference numbers (or names) as the elements of any other figure can operate or function in any manner similar to that described, but are not limited to such.

Table 600 shows traditional packet filter components (like Tables 200 and 300) plus identifiers for application type (10000001) and application attention indicator (10000010) in the reserved region 601, according to some embodiments. While the embodiments define the application type identifier with “10000001” and application attention indicator with “10000010” other values for the identifiers may be used to define the application type and application attention indicator identifier so long as the identifiers are unique in the packet.

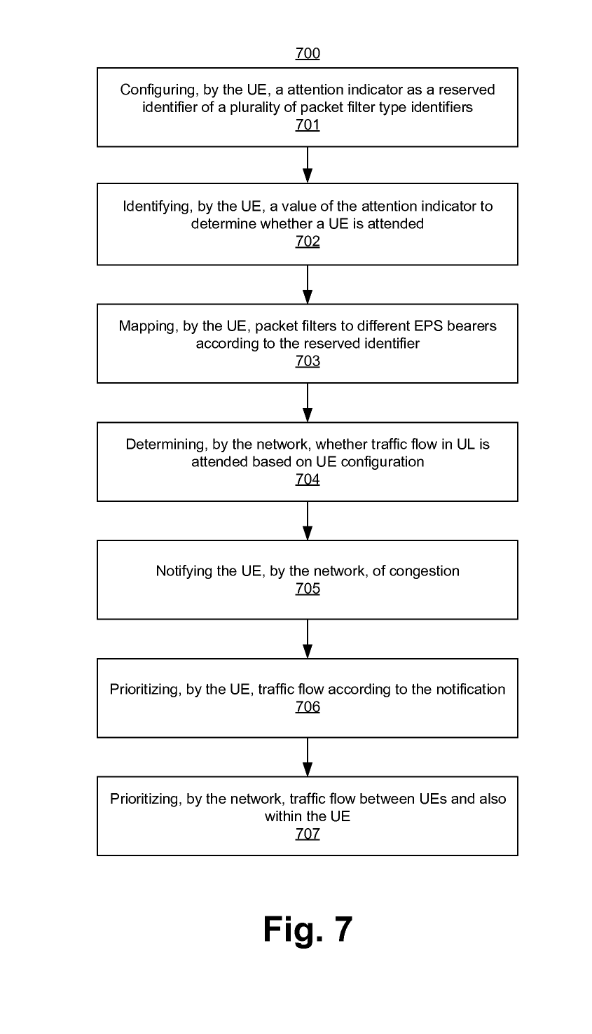

FIG. 7 illustrates flowchart 700 for managing traffic according to packets being identified as attended or unattended, according to some embodiments of the disclosure. It is pointed out that those elements of FIG. 7 having the same reference numbers (or names) as the elements of any other figure can operate or function in any manner similar to that described, but are not limited to such.

Although the blocks in the flowchart with reference to FIG. 7 are shown in a particular order, the order of the actions can be modified. Thus, the illustrated embodiments can be performed in a different order, and some actions/blocks may be performed in parallel. Some of the blocks and/or operations listed in FIG. 7 are optional in accordance with certain embodiments. The numbering of the blocks presented is for the sake of clarity and is not intended to prescribe an order of operations in which the various blocks must occur. Additionally, operations from the various flows may be utilized in a variety of combinations.

At block 701, UE based attention indicator is configured in a reserved section 201 of packet filter identifiers as shown with reference to Table 200. In some embodiments, packet filters 402 (e.g., 126 in UE 120) for UL are configured with the attention indicator. In some embodiments, the identifier of the attention indicator may be stored in a register. The identifier of the attention indicator is unique among the identifiers of the packet filter identifiers. The identifier to the attention indicator is like a pointer to the attention indicator that informs packet filter 402 whether the packet associated with UE traffic data 401 is attended or unattended.

At block 702, one or more packet filters 402 identify the value associated with the attention indicator to determine whether the packet is attended or unattended. In some embodiments, based on that criterion, traffic data 401 is managed via packet filter 402 and bearers to manage network traffic congestion. In some embodiments, UE 101 maps the traffic into the appropriate packet filter 402 taking into account that indicator.

At block 703, packet filters 402 are mapped to different EPS bearers according to the attention indicator. Various EPS bearers are described with reference to FIG. 1A. Referring back to FIG. 7, in some embodiments, based on that criterion along with whether the packet in traffic 401 is classified as attended or unattended, traffic data 401 is managed via packet filter 402 and EPS bearers to manage network traffic congestion. In some embodiments, the network notifies UE 101 of congestion and UE 101 thereafter prioritizes traffic flows.

In some embodiments, an application type indicator is configured in a reserved section 501 of packet filter identifiers as shown with reference to Table 500. The identifier of the application type indicator may be stored in another register, separate from the register storing the attention indicator. The identifier of the application type indicator is unique among the identifiers of the packet filter identifiers. The identifier to the application type indicator is like a pointer to the application type indicator that informs packet filter 402 the congestion level or priority of an application for execution on UE 101. In some embodiments, one or more packet filters 402 identify the value associated with the application type indicator to determine the congestion level or priority of the application.

In some embodiments, an application attention indicator is configured in a reserved section 301 of packet filter identifiers as shown with reference to Table 300. The identifier of the application attention indicator may be stored in a unique register. The identifier of the application attention indicator is unique among the identifiers of the packet filter identifiers. In some embodiments, the identifier to the application attention indicator is like a pointer to the indicator that informs packet filter 402 whether the packet associated with the application traffic data 401 is attended or unattended. In some embodiments, one or more packet filters 402 identify the value associated with the application attention indicator to determine whether the packet in traffic data 401 is attended or unattended. In some embodiments, based on that criterion and the value associated with the application type identifier, the traffic data is managed via packet filter 402 and EPS bearers to manage network traffic congestion.

At block 704, the network determines whether traffic flow in UL is attended based on the configuration of UE 101. At block 705, UE 101 is notified by the network of any congestion so UE 101 can consider re-prioritizing the traffic flow. At block 706, UE 101 prioritizes traffic flow according to the notification. At block 707, in some embodiments, the network also prioritizes traffic flow between UEs and also within one UE (e.g., UE 101).

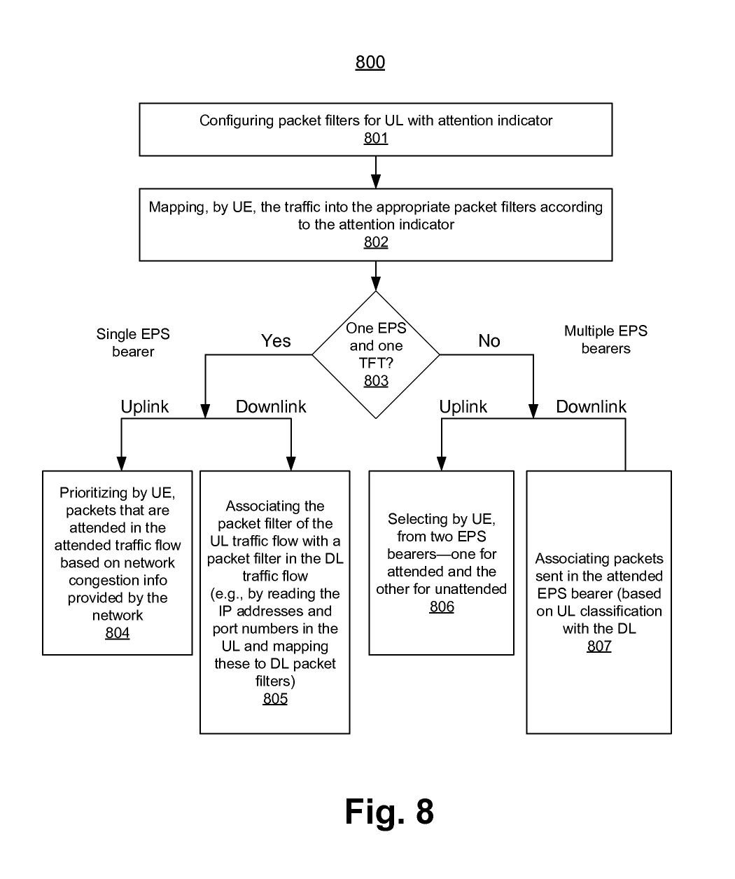

FIG. 8 illustrates flowchart 800 for managing traffic according to packets being identified as attended or unattended, according to some embodiments of the disclosure. Although the blocks in the flowchart with reference to FIG. 8 are shown in a particular order, the order of the actions can be modified. Thus, the illustrated embodiments can be performed in a different order, and some actions/blocks may be performed in parallel. Some of the blocks and/or operations listed in FIG. 8 are optional in accordance with certain embodiments. The numbering of the blocks presented is for the sake of clarity and is not intended to prescribe an order of operations in which the various blocks must occur. Additionally, operations from the various flows may be utilized in a variety of combinations.

At block 801, UE 101 configures packet filters 402 for UL transmission with attention indicator. At block 802, UE 101 maps traffic 401 into appropriate packet filters 402 according to the attention indicator defined in the reserved section(s) 201/301 of packet filter identifiers as described with reference to Table 200 and Table 300. Depending on the bearer configuration, different functions are performed for uplink and downlink. At block 803, a determination is made whether there is one EPS and TFT.

If it is determined that the system has a single EPS bearer and TFT, then at block 804 for uplink transmission, UE 101 prioritizes packets that are attended in the attended traffic flow. With one EPS bearer and one TFT, in some embodiments, each IP address/port number is mapped to either attended or unattended, but may not be mapped to both. In UL, in some embodiments, based on the information provided by the network on congestion, UE 101 prioritizes packets 401 that are attended (in the attended traffic flow) to TFT 403.

In DL, as shown with reference to block 805, the entity responsible for filtering the packets (e.g., PGW 104 but may reside somewhere else) binds the packet filter of the UL traffic flow with a packet filter in the DL traffic flow (e.g., by reading the IP addresses and port numbers in the UL and mapping those to DL packet filters). In some embodiments, packets that belong to DL traffic flow which are attended in the associated UL are considered attended as well. In some embodiments, the network prioritizes those attended packets over unattended packets.

If it is determined that the system has multiple EPS bearers, then at block 806 for uplink transmission, UE 101 selects different EPS bearers for attended and unattended packet flow. With multiple EPS bearer, in some embodiments, a given IP address/port number is mapped to either attended or unattended, and UE 101 can choose which one to use. In some embodiments, in UL, UE 101 has two EPS bearers to choose from—one is attended and the other is unattended. In some embodiments, for each application at each given time, UE 101 chooses one of the EPS bearers to use. In some embodiments, UE 101 may use both EPS bearers at the same time. In some embodiments, UE 101 gives different priority to each EPS bearer when there is congestion. In some embodiments, UE 101 prioritizes packets that are attended in the attended traffic flow and maps those packets to the attended EPS bearer.

In DL, as described with reference to block 807, the entity responsible for filtering the packets (e.g., PGW 104) associates the packets sent in the attended UL EPS bearer (based on the UL classification) with the DL. This association allows the network to prioritize attended packets over unattended packets.

FIG. 9 illustrates a UE 1600 with apparatus capable of managing traffic according to packets being identified as attended or unattended, according to some embodiments of the disclosure. It is pointed out that those elements of FIG. 9 having the same reference numbers (or names) as the elements of any other figure can operate or function in any manner similar to that described, but are not limited to such.

UE 1600 may be a smart device or a computer system or a SoC with capable of managing traffic according to packets being identified as attended or unattended, according to some embodiments of the disclosure. FIG. 9 illustrates a block diagram of an embodiment of a mobile device in which flat surface interface connectors could be used. In one embodiment, computing device 1600 represents a mobile computing device, such as a computing tablet, a mobile phone or smart-phone, a wireless-enabled e-reader, or other wireless mobile device. It will be understood that certain components are shown generally, and not all components of such a device are shown in computing device 1600.

In one embodiment, computing device 1600 includes a first processor 1610 with the capability of managing traffic according to packets being identified as attended or unattended, according to some embodiments discussed. Other blocks of the computing device 1600 may also include the apparatus capable of managing traffic according to packets being identified as attended or unattended of some embodiments. The various embodiments of the present disclosure may also comprise a network interface within 1670 such as a wireless interface so that a system embodiment may be incorporated into a wireless device, for example, cell phone or personal digital assistant.

In one embodiment, processor 1610 (and/or processor 1690) can include one or more physical devices, such as microprocessors, application processors, microcontrollers, programmable logic devices, or other processing means. The processing operations performed by processor 1610 include the execution of an operating platform or operating system on which applications and/or device functions are executed. The processing operations include operations related to I/O (input/output) with a human user or with other devices, operations related to power management, and/or operations related to connecting the computing device 1600 to another device. The processing operations may also include operations related to audio I/O and/or display I/O.

In one embodiment, computing device 1600 includes audio subsystem 1620, which represents hardware (e.g., audio hardware and audio circuits) and software (e.g., drivers, codecs) components associated with providing audio functions to the computing device. Audio functions can include speaker and/or headphone output, as well as microphone input. Devices for such functions can be integrated into computing device 1600, or connected to the computing device 1600. In one embodiment, a user interacts with the computing device 1600 by providing audio commands that are received and processed by processor 1610.

Display subsystem 1630 represents hardware (e.g., display devices) and software (e.g., drivers) components that provide a visual and/or tactile display for a user to interact with the computing device 1600. Display subsystem 1630 includes display interface 1632, which includes the particular screen or hardware device used to provide a display to a user. In one embodiment, display interface 1632 includes logic separate from processor 1610 to perform at least some processing related to the display. In one embodiment, display subsystem 1630 includes a touch screen (or touch pad) device that provides both output and input to a user.

I/O controller 1640 represents hardware devices and software components related to interaction with a user. I/O controller 1640 is operable to manage hardware that is part of audio subsystem 1620 and/or display subsystem 1630. Additionally, I/O controller 1640 illustrates a connection point for additional devices that connect to computing device 1600 through which a user might interact with the system. For example, devices that can be attached to the computing device 1600 might include microphone devices, speaker or stereo systems, video systems or other display devices, keyboard or keypad devices, or other I/O devices for use with specific applications such as card readers or other devices.

As mentioned above, I/O controller 1640 can interact with audio subsystem 1620 and/or display subsystem 1630. For example, input through a microphone or other audio device can provide input or commands for one or more applications or functions of the computing device 1600. Additionally, audio output can be provided instead of, or in addition to display output. In another example, if display subsystem 1630 includes a touch screen, the display device also acts as an input device, which can be at least partially managed by I/O controller 1640. There can also be additional buttons or switches on the computing device 1600 to provide I/O functions managed by I/O controller 1640.

In one embodiment, I/O controller 1640 manages devices such as accelerometers, cameras, light sensors or other environmental sensors, or other hardware that can be included in the computing device 1600. The input can be part of direct user interaction, as well as providing environmental input to the system to influence its operations (such as filtering for noise, adjusting displays for brightness detection, applying a flash for a camera, or other features).

In one embodiment, computing device 1600 includes power management 1650 that manages battery power usage, charging of the battery, and features related to power saving operation. Memory subsystem 1660 includes memory devices for storing information in computing device 1600. Memory can include nonvolatile (state does not change if power to the memory device is interrupted) and/or volatile (state is indeterminate if power to the memory device is interrupted) memory devices. Memory subsystem 1660 can store application data, user data, music, photos, documents, or other data, as well as system data (whether long-term or temporary) related to the execution of the applications and functions of the computing device 1600.

Elements of embodiments are also provided as a machine-readable medium (e.g., memory 1660) for storing the computer-executable instructions (e.g., instructions to implement any other processes discussed herein). The machine-readable medium (e.g., memory 1660) may include, but is not limited to, flash memory, optical disks, CD-ROMs, DVD ROMs, RAMs, EPROMs, EEPROMs, magnetic or optical cards, phase change memory (PCM), or other types of machine-readable media suitable for storing electronic or computer-executable instructions. For example, embodiments of the disclosure may be downloaded as a computer program (e.g., BIOS) which may be transferred from a remote computer (e.g., a server) to a requesting computer (e.g., a client) by way of data signals via a communication link (e.g., a modem or network connection).

Connectivity 1670 includes hardware devices (e.g., wireless and/or wired connectors and communication hardware) and software components (e.g., drivers, protocol stacks) to enable the computing device 1600 to communicate with external devices. The computing device 1600 could be separate devices, such as other computing devices, wireless access points or base stations, as well as peripherals such as headsets, printers, or other devices.

Connectivity 1670 can include multiple different types of connectivity. To generalize, the computing device 1600 is illustrated with cellular connectivity 1672 and wireless connectivity 1674. Cellular connectivity 1672 refers generally to cellular network connectivity provided by wireless carriers, such as provided via GSM (global system for mobile communications) or variations or derivatives, CDMA (code division multiple access) or variations or derivatives, TDM (time division multiplexing) or variations or derivatives, or other cellular service standards. Wireless connectivity (or wireless interface) 1674 refers to wireless connectivity that is not cellular, and can include personal area networks (such as Bluetooth, Near Field, etc.), local area networks (such as Wi-Fi), and/or wide area networks (such as WiMax), or other wireless communication.

Peripheral connections 1680 include hardware interfaces and connectors, as well as software components (e.g., drivers, protocol stacks) to make peripheral connections. It will be understood that the computing device 1600 could both be a peripheral device (“to” 1682) to other computing devices, as well as have peripheral devices (“from” 1684) connected to it. The computing device 1600 commonly has a “docking” connector to connect to other computing devices for purposes such as managing (e.g., downloading and/or uploading, changing, synchronizing) content on computing device 1600. Additionally, a docking connector can allow computing device 1600 to connect to certain peripherals that allow the computing device 1600 to control content output, for example, to audiovisual or other systems.

In addition to a proprietary docking connector or other proprietary connection hardware, the computing device 1600 can make peripheral connections 1680 via common or standards-based connectors. Common types can include a Universal Serial Bus (USB) connector (which can include any of a number of different hardware interfaces), DisplayPort including MiniDisplayPort (MDP), High Definition Multimedia Interface (HDMI), Firewire, or other types.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may,” “might,” or “could” be included, that particular component, feature, structure, or characteristic is not required to be included. If the specification or claim refers to “a” or “an” element, that does not mean there is only one of the elements. If the specification or claims refer to “an additional” element, that does not preclude there being more than one of the additional element.

Furthermore, the particular features, structures, functions, or characteristics may be combined in any suitable manner in one or more embodiments. For example, a first embodiment may be combined with a second embodiment anywhere the particular features, structures, functions, or characteristics associated with the two embodiments are not mutually exclusive.

While the disclosure has been described in conjunction with specific embodiments thereof, many alternatives, modifications and variations of such embodiments will be apparent to those of ordinary skill in the art in light of the foregoing description. For example, other memory architectures e.g., Dynamic RAM (DRAM) may use the embodiments discussed. The embodiments of the disclosure are intended to embrace all such alternatives, modifications, and variations as to fall within the broad scope of the appended claims.

In addition, well known power/ground connections to integrated circuit (IC) chips and other components may or may not be shown within the presented figures, for simplicity of illustration and discussion, and so as not to obscure the disclosure. Further, arrangements may be shown in block diagram form in order to avoid obscuring the disclosure, and also in view of the fact that specifics with respect to implementation of such block diagram arrangements are highly dependent upon the platform within which the present disclosure is to be implemented (i.e., such specifics should be well within purview of one skilled in the art). Where specific details (e.g., circuits) are set forth in order to describe example embodiments of the disclosure, it should be apparent to one skilled in the art that the disclosure can be practiced without, or with variation of, these specific details. The description is thus to be regarded as illustrative instead of limiting.

The following examples pertain to further embodiments. Specifics in the examples may be used anywhere in one or more embodiments. All optional features of the apparatus described herein may also be implemented with respect to a method or process.

For example, a UE is provided which comprises: a transmitter to transmit traffic over the network to a eNB, the traffic having packets from one or more applications; and logic to configure one or more packet filters for uplink transmission with an indicator, wherein the indicator to identify whether the one or more applications is attended or unattended, wherein at least one of EPS bearers is configured with a TFT, and wherein the TFT includes the one or more packet filters. In some embodiments, the UE further comprises logic to map the traffic into the packet filters according to the indicator. In some embodiments, the UE further comprises logic which is operable to prioritize uplink packets from the attended one or more applications over uplink packets from the unattended one or more applications.

In some embodiments, the UE further comprises logic to bind a packet to a packet filter from among the one or more packet filters according to the indicator. In some embodiments, the UE further comprises logic to assign a priority to at least one EPS bearer from at least two EPS bearers such that an EPS bearer for packets from the one or more attended applications has a higher priority than an EPS bearer for packets from the unattended one or more applications. In some embodiments, the transmitter is operable to transmit value of the indicator periodically or upon request to the network.

In some embodiments, the indicator is a reserved identifier of a plurality of packet filter type identifiers. In some embodiments, the UE comprises logic to configure the reserved identifier of the plurality of packet filter type identifiers. In some embodiments, the indicator is part of a RRC message or a MAC header.

In another example, an eNB is provided which comprises: a receiver to receive traffic over the network from the UE, the traffic having packets from one or more applications; logic to bind a packet filter from among one or more packet filters of an uplink traffic flow with a packet filter in a downlink traffic flow, wherein at least one of EPS bearers is configured with a TFT, and wherein the TFT includes the one or more packet filters; and logic to classify the one or more applications for the downlink traffic flow as attended or unattended according to a configuration of the binded packet filter of the uplink traffic flow.

In some embodiments, the eNB further comprises logic to notify the UE of congestion, wherein the UE prioritizes the uplink traffic flow in response to the notification. In some embodiments, the configuration of the binded packet filter indicates whether the binded packet filter is to filter packets according to the one or more applications being classified as attended or unattended. In some embodiments, the eNB further comprises logic to prioritize the downlink attended packets from the attended one or more applications over the downlink packets from the unattended one or more applications. In some embodiments, the logic to bind the packet filter is to compare an IP address in an uplink packet filter with an IP address in a downlink packet filter.

In another example, PGW is provided which comprises: logic to bind a packet filter of an uplink traffic flow with a packet filter in a downlink traffic flow; and logic to label packets for downlink traffic as attended or unattended in the downlink traffic flow when the associated packet filter of the uplink traffic flow is identified as attended or unattended, respectively. In some embodiments, the logic to bind the packet filter is to compare an IP address in an uplink packet filter with an IP address in a downlink packet filter. In some embodiments, an eNB applies the label to perform downlink packet scheduling. In some embodiments, an eNB notifies a UE of congestion, and wherein the UE prioritizes the uplink traffic flow in response to the notification.

In another example, a method is provided which comprises configuring a TFT associated with at least one of EPS bearers, wherein the TFT includes one or more packet filters; configuring the one or more packet filters for uplink transmission with an indicator that identifies whether one or more applications is attended or unattended; and mapping packets from the one or more applications into a packet filter from among the one or more packet filters according to the indicator. In some embodiments, the method comprises transmitting a value of the indicator periodically or upon request transmitting the value to the network.

In some embodiments, the method comprises configuring the indicator as a reserved identifier of a plurality of packet filter type identifiers. In some embodiments, the indicator is part of a RRC message or a MAC header. In some embodiments, the method comprises prioritizing the packets for uplink transmission when the indicator identifies that the associated application is attended. In some embodiments, the method further comprising assigning a priority to at least one EPS bearer from at least two EPS bearers such that an EPS bearer for an attended application has a higher priority than an EPS bearer for an unattended application.

In another example, a machine readable storage media is provided having machine executable instructions that when executed cause one or more processors to perform a method according to the method described above.

In another example, a UE is provided which comprises: means for configuring a TFT associated with at least one of EPS bearers, wherein the TFT includes one or more packet filters; means for configuring the one or more packet filters for uplink transmission with an indicator that identifies whether one or more applications is attended or unattended; and means for mapping packets from the one or more applications into a packet filter from among the one or more packet filters according to the indicator.

In some embodiments, the UE comprises means for transmitting a value of the indicator periodically or upon request transmitting the value to the network. In some embodiments, the UE comprises means for configuring the indicator as a reserved identifier of a plurality of packet filter type identifiers. In some embodiments, the indicator is part of a RRC message or a MAC header. In some embodiments, the UE comprises means for prioritizing the packets for uplink transmission when the indicator identifies that the associated application is attended. In some embodiments, the further comprises means for assigning a priority to at least one EPS bearer from at least two EPS bearers such that an EPS bearer for an attended application has a higher priority than an EPS bearer for an unattended application.

An abstract is provided that will allow the reader to ascertain the nature and gist of the technical disclosure. The abstract is submitted with the understanding that it will not be used to limit the scope or meaning of the claims. The following claims are hereby incorporated into the detailed description, with each claim standing on its own as a separate embodiment.

We claim:

1. A User Equipment (UE) to communicate with an Evolved Node-B (eNB) on a network, the UE comprising:
a transmitter to transmit traffic over the network to the eNB, the traffic having packets from one or more applications; and
logic to configure one or more packet filters for uplink transmission with an indicator, wherein the indicator to identify whether the one or more applications is attended or unattended, wherein at least one of Evolved Packet System (EPS) bearers is configured with a Traffic Flow Template (TFT), and wherein the TFT includes the one or more packet filters.

2. The UE of claim 1 further comprises logic to map the traffic into the packet filters according to the indicator.

3. The UE of claim 1 further comprises logic which is operable to prioritize uplink packets from the attended one or more applications over uplink packets from the unattended one or more applications.

4. The UE of claim 1 further comprises logic to bind a packet to a packet filter from among the one or more packet filters according to the indicator.

5. The UE of claim 1 further comprises logic to assign a priority to at least one EPS bearer from at least two EPS bearers such that an EPS bearer for packets from the one or more attended applications has a higher priority than an EPS bearer for packets from the unattended one or more applications.

6. The UE of claim 1, wherein the transmitter is operable to transmit value of the indicator periodically or upon request to the network.

7. The UE of claim 1, wherein the indicator is a reserved identifier of a plurality of packet filter type identifiers.

8. The UE of claim 7 comprises logic to configure the reserved identifier of the plurality of packet filter type identifiers.

9. The UE of claim 1, wherein the indicator is part of a Radio Resource Control (RRC) message or a Media Access Control (MAC) header.

10. An Evolved Node-B (eNB) to communicate with a User Equipment (UE) on a network, the eNB comprising:
a receiver to receive traffic over the network from the UE, the traffic having packets from one or more applications;
logic to bind a packet filter from among one or more packet filters of an uplink traffic flow with a packet filter in a downlink traffic flow, wherein at least one of Evolved Packet System (EPS) bearers is configured with a Traffic Flow Template (TFT), and wherein the TFT includes the one or more packet filters; and
logic to classify the one or more applications for the downlink traffic flow as attended or unattended according to a configuration of the binded packet filter of the uplink traffic flow.

11. The eNB of claim 10 further comprises logic to notify the UE of congestion, wherein the UE prioritizes the uplink traffic flow in response to the notification.

12. The eNB of claim 10, wherein the configuration of the binded packet filter indicates whether the binded packet filter is to filter packets according to the one or more applications being classified as attended or unattended.

13. The eNB of claim 10 further comprises logic to prioritize the downlink attended packets from the attended one or more applications over the downlink packets from the unattended one or more applications.

14. The eNB of claim 10, wherein the logic to bind the packet filter is to compare an IP address in an uplink packet filter with an IP address in a downlink packet filter.

15. A Public Data Network (PDN) Gateway (PGW) comprising:
logic to bind a packet filter of an uplink traffic flow with a packet filter in a downlink traffic flow; and
logic to label packets for downlink traffic as attended or unattended in the downlink traffic flow when the associated packet filter of the uplink traffic flow is identified as attended or unattended, respectively.

16. The PGW of claim 15, wherein the logic to bind the packet filter is to compare an IP address in an uplink packet filter with an IP address in a downlink packet filter.

17. The PGW of claim 15, wherein an Evolved Node-B (eNB) to apply the label to perform downlink packet scheduling.

18. The PGW of claim 15, wherein an Evolved Node-B (eNB) to notify a User Equipment (UE) of congestion, and wherein the UE prioritizes the uplink traffic flow in response to the notification.

19. A machine readable storage media having machine executable instructions, that when executed, cause one or more processors to perform an operation comprising:
configuring a Traffic Flow Template (TFT) associated with at least one of Evolved Packet System (EPS) bearers, wherein the TFT includes one or more packet filters;
configuring the one or more packet filters for uplink transmission with an indicator that identifies whether one or more applications is attended or unattended; and
mapping packets from the one or more applications into a packet filter from among the one or more packet filters according to the indicator.

20. The machine readable storage media of claim 19 having further instructions that when executed cause the one or more processors to perform an operation comprising transmitting a value of the indicator periodically or upon request transmitting the value to the network.

21. The machine readable storage media of claim 19 having further instructions that when executed cause the one or more processors to perform an operation comprising configuring the indicator as a reserved identifier of a plurality of packet filter type identifiers.

22. The machine readable storage media of claim 19, wherein the indicator is part of a Radio Resource Control (RRC) message or a Media Access Control (MAC) header.

23. The machine readable storage media of claim 19 having further instructions that when executed cause the one or more processors to perform an operation comprising prioritizing the packets for uplink transmission when the indicator identifies that the associated application is attended.

24. The machine readable storage media of claim 19 having further instructions that when executed cause the one or more processors to perform an operation further comprising assigning a priority to at least one EPS bearer from at least two EPS bearers such that an EPS bearer for an attended application has a higher priority than an EPS bearer for an unattended application.
